(19) United States
(12) Patent Application Publication
(10) Pub. No.: US 2012/0323152 A1
(43) Pub. Date: Dec. 20, 2012

(54) COMPRESSION DEVICE

(75) Inventor: Shai Yehoshua Schubert, Brookline, MA (US)

(73) Assignee: Portable Therapeutix, LLC

(21) Appl. No.: 13/523,632

(22) Filed: Jun. 14, 2012

Related U.S. Application Data
(60) Provisional application No. 61/497,050, filed on Jun. 14, 2011.
(60) Provisional application No. 61/497,059, filed on Jun. 15, 2011.

(51) Int. Cl. A61H 9/00

(52) U.S. Cl. 601/149; 601/148; 601/151

(57) ABSTRACT

Described are improved apparatus and devices for intermittently and sequentially compressing a body site and methods for using said apparatus and devices, especially for site specific treatment to achieve a desired temperature of the underlying tissue. The apparatus includes a first segment cooperative with a fluid chamber, the fluid chamber adapted for inflation by fluid; and a second segment cooperative with the first segment, the second segment housing a temperature sensitive material, wherein the temperature sensitive material is uniquely compartmentalized in the second segment.

### CROSS-REFERENCE TO RELATED APPLICATIONS

This application claims the benefit of U.S. Provisional Patent Application No. 61/497,050 filed Jun. 14, 2011, and U.S. Provisional Patent Application No. 61/497,059 filed Jun. 15, 2011, the specifications and drawings of which are incorporated herein by reference in their entirety.

### BACKGROUND

The invention described relates generally to compression devices, including those used for treatment of a body site of interest in a person.

Compression devices have been used to apply pressure to a part of the body. The devices can apply pressure sequentially or simultaneously. These devices are often combined with other modes of therapy to treat a site of interest, such as with a cold therapy. Complications with some devices have arisen because of the type of compression and/or the placement or positioning of the device. There remains a need for compression devices that provide proper placement, offer site specific compression with high and reproducible effectiveness, may be optimally temperature controlled and are also portable.

### SUMMARY

Described herein are improved devices for intermittently and sequentially compressing a site specific area of the body and methods for using said devices.

In one form is an apparatus configured for placement on a person at a specific site of the body, the apparatus comprising a first segment cooperative with a fluid chamber, the fluid chamber adapted for inflation by fluid from a fluid source; and a second segment cooperative with the first segment, the second segment housing a temperature sensitive material, wherein the temperature sensitive material is compartmentalized in the second segment in a manner that prevents migration and/or is not equally distributed in the second segment. The temperature sensitive material may be compartmentalized in a plurality of chambers in the second chamber. The compartments in the second chamber may be the same as and align with one or more chambers in the fluid chamber. The temperature sensitive material may include a chemical indicator. The temperature sensitive material may be a hydrogel. The first segment may be shaped for positioning about only a portion of a joint. The first segment may be shaped for positioning about a front portion of a knee. The apparatus may further comprise one or more fasteners cooperative with and extending from the first segment for securing the first and second segments about the site of the body. The fluid introduced to the fluid chamber may be controlled by a predefined algorithm. The fluid introduced to the fluid chamber is controlled by a controller having one or more predefined settings. A control unit associate with the apparatus may control operation of the apparatus, the control unit selected from the group consisting of external device, internal controller and combinations thereof. The apparatus may further comprise one or more ergonomically positioned fasteners cooperative with and extending from the first segment for securing the first and second segments about the body site without compressing one or more sensitive regions near the body site and/or preventing migration of the fasteners from their initial position. The first segment may be selectively shaped for positioning about only a portion of a joint. The second segment may be further shaped prior to its cooperation with the first segment (from a first shape to a second shape). Inflation of the fluid chamber may be performed by a portable unit adapted for and coupled with the first segment. The fluid chamber may be contained within the first segment. The fluid chamber and the second segment may be of a similar size in at least two dimensions. The fluid chamber may be filled intermittently whereby intermittent filling comprises a period of inflation and a period of deflation, wherein the period of inflation is not the same as the period of deflation. The fluid chamber may be filled intermittently whereby intermittent filling comprises a period of inflation and a period of deflation, wherein the period of inflation is the same as the period of deflation.

In other forms, described herein is a therapy system for use and placement on a body site of a person, the system comprising: a first segment comprising a fluid chamber adapted for inflation; a second segment comprising a temperature sensitive material, wherein the temperature sensitive material is compartmentalized in the second segment to prevent migration, and wherein, the first and second segments are removably coupled to one another; a fluid source fluidly coupled to the fluid chamber; and one or more extending members for coupling to and extending from the first segment, the one or more extending member for securing the first segment about the body site, wherein at last a portion of the one or more extending members are shaped curvilinearly to prevent their migration from an initial position. The inflation may be intermittent. Inflation of the fluid chamber provides compression to the body site and the total time for compression may be about thirty minutes or less. Inflation of the fluid chamber may provide compression to all of the temperature sensitive material in a sequential manner. The fluid chamber may be contained within the first segment. The fluid chamber may overlap substantially all of the temperature sensitive material to provide compression to substantially all of the temperature sensitive material. The second segment may be removably secured to the first segment. The first and second segments may be of a similar size in at least two dimensions. The system typically further comprises a control unit having one or more predefined algorithms for achieving a desired temperature on the body site by adjusting one or both of a fluid pressure and time of inflation associated with the fluid chamber.

In still other forms is a method of introducing a therapy system on a person at a body site comprising: providing an apparatus to only the body site, the apparatus comprising: at least a first segment cooperative with a fluid chamber, the fluid chamber adapted for intermittent inflation by a fluid; a fluid source fluidly coupled to the fluid chamber to introduce the fluid to the fluid chamber; and one or more extending members ergonomically positioned for coupling to and extending from the first segment and for securing the first segment about the body site without migrating from an initial position and/or one or more extending members ergonomically positioned for coupling to and extending from the first segment and for securing the first segment about the body site without compressing one or more sensitive regions near the body site. The method further comprises introducing fluid intermittently for a defined period of time to the fluid chamber thereby intermittently compressing only the body site while maintaining the one or more extending members in their initial position. The method may include coupling a temperature sensitive material with the first segment. The fluid may be introduced for about thirty minutes or less. The fluid chamber may be compartmentalized introducing fluid sequentially and intermittently to the body site, wherein the sequential compression is from a distal portion of the body site to a proximal portion of the body site.

### BRIEF DESCRIPTION OF THE DRAWINGS

For a more complete understanding of the description provided herein and the advantages thereof, reference is now made to the brief descriptions below, taken in connection with the accompanying drawings and detailed description, wherein like reference numerals represent like parts.

FIG. 1A depicts a representative device with a view of one of its outwardly facing surfaces and accompanying components as described herein.

FIGS. 1B and 1E depict representative leakproof elements described herein.

FIGS. 1C and 1D depict representative bladders described herein.

FIG. 1F depicts the leakproof element of FIG. 1B after further shaping for placement on a portion of the body.

FIG. 1G depicts the opposing outwardly facing surface of the representative device of FIG. 1A.

FIGS. 2A-2J depict representative first segments described herein.

FIG. 3A depicts a front view of the first segment of FIG. 2A.

FIG. 3B depicts a front view of the first segment of FIG. 2B.

FIG. 3C depicts a front view of the first segment of FIG. 2C.

FIGS. 4A-4C depict further representative first segments with detachable second segments described herein.

FIG. 4D depicts a front view of the first and second segments of FIG. 4A.

FIGS. 5A and 5B depict a side view and plan view, respectively, of a representative device described herein.

FIG. 5C depicts another representative first segment with a detachable second segment described herein.

FIGS. 6A-6C depict various photographs of a further representative device without the second segment (6A), with the second segment on cooperation with the first segment (6B) and with the detached second segment, as described herein.

FIGS. 7A and 7B depict views of a representative device described herein in place on the body and positioned in flexion and in extension, respectively.

FIGS. 8A and 8B depict views of another representative device described herein in place on the body and positioned in flexion and in extension, respectively.

FIGS. 9A and 9B depict views a further representative device described herein in place on the body and positioned in flexion and in extension, respectively.

FIGS. 10A and 10B depict views of still another representative device described herein in place on the body and positioned in flexion and in extension, respectively.

FIGS. 11A and 11B depict views of yet another representative device described herein, showing placement on the body and positioned in flexion (11A) or not on the body (11B).

FIGS. 12A-12C depict a further representative device described herein showing a side view in place on the body and positioned in flexion (12A) or a plan view in place on the body and positioned in flexion (12C) or not on the body (12B).

FIGS. 13A-13C depict a still further representative device described herein showing a side view in place on the body and positioned in flexion (13A) or a plan view in place on the body and positioned in flexion (13C) or not on the body (13B).

FIGS. 14A-14C depict another representative device described herein showing a side view in place on the body and positioned in flexion (14A) or a plan view in place on the body and positioned in flexion (14C) or not on the body (14B).

FIGS. 15A-15C depict yet another representative device described herein showing a side view in place on the body and positioned in flexion (15A) or a plan view in place on the body and positioned in flexion (15C) or not on the body (15B).

FIGS. 16A-16C depict another representative device described herein showing a side view in place on the body and positioned in flexion (16A) or a plan view in place on the body and positioned in flexion (16C) or not on the body (16B).

FIG. 17A depicts another representative device described herein with a portable source, the source shown in plan view is depicted in FIG. 17B.

FIG. 18A depicts another representative device described herein with a portable source, the source shown in plan view (FIG. 18B) and in top view (FIG. 18C) is also depicted.

FIGS. 19A and 19B depict still another representative device with a portable source shown in plan view and side view, respectively.

FIG. 20 depicts temperature measurements in a muscle at various muscle depths before treatment (T-O, diamonds), after treatment for 15 minutes with intermittent compression and concomitant temperature (compression, triangles), and after treatment for 15 minutes with the same temperature and no intermittent compression (no compression, squares).

FIG. 21 depicts temperature measurements taken at various time points at the knee when provided with a representative device described herein (IC, triangles) as compared with a comparative device (No IC, squares).

FIG. 22 depicts tissue oxygenation measurements taken at various time points at the knee when provided with a representative device described herein (IC, diamonds) as compared with a comparative device (No IC, triangles).

FIG. 23 depicts additional tissue oxygenation measurements taken at various time points at the knee when provided with a representative device described herein (IC, triangles) as compared with a comparative device (No IC, square).

FIG. 24 depicts temperature measurements taken at various time points at the knee when provided with a representative device described herein (IC-knee, triangles) as compared with a comparative device (IC-leg, square).

FIG. 25 depicts tissue oxygenation measurements taken at various time points at the knee when provided treatment with a device described herein (IC-knee, diamond) as compared with a comparative device (IC-leg, triangles).

FIG. 26 depicts additional tissue oxygenation measurements taken at various time points at the knee when provided treatment with a device described herein (IC-knee, triangles) as compared with a comparative device (IC-leg, squares).

FIGS. 27-30 depict further representative devices on anatomic structures as described herein.

### DESCRIPTION

In the description which follows like parts are marked throughout the specification and drawing with the same reference numerals respectively. The drawing figures are not necessarily to scale and certain features may be shown in generalized or schematic form in the interest of clarity and conciseness or for informational purposes.

Described herein are compression devices and methods of operation and use for compression treatment of one or more body sites or anatomic structures. The compression treatment may be for an acute injury, chronic injury, after surgery or recovery from other injury, for pain or inflammation, for use after exercise, or to prevent injury or worsening of an existing condition to the one or more body sites. The device promotes sequential compression of a fluid within the device in a direction towards the heart when the device is positioned on or about the body site. Compression is intermittent, generally applied in a predetermined fashion upon proper placement of the device and performed with sequential movement and/or distribution of the fluid (e.g., gas, liquid, etc.) on or about the body site. Fluid movement follows a predefined algorithm as further described herein; generally fluid movement is in a direction towards the heart, hence from a more distal location to a more proximal location. The device itself may be worn while a person is stationary or in motion. In many embodiments, the device includes a temperature adjustable component or temperature sensitive component, which, when combined with the compression and with a pre-defined algorithm, provides a controlled environment for efficacious treatment on or about the body site. Various components of the device may be reusable, washable, and/or disposable.

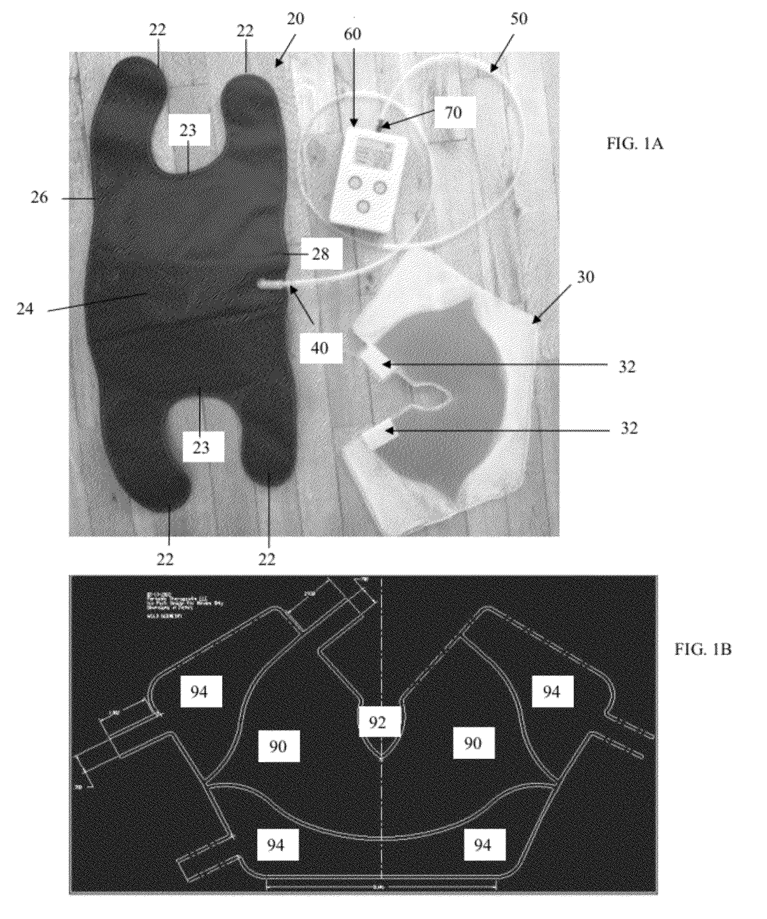

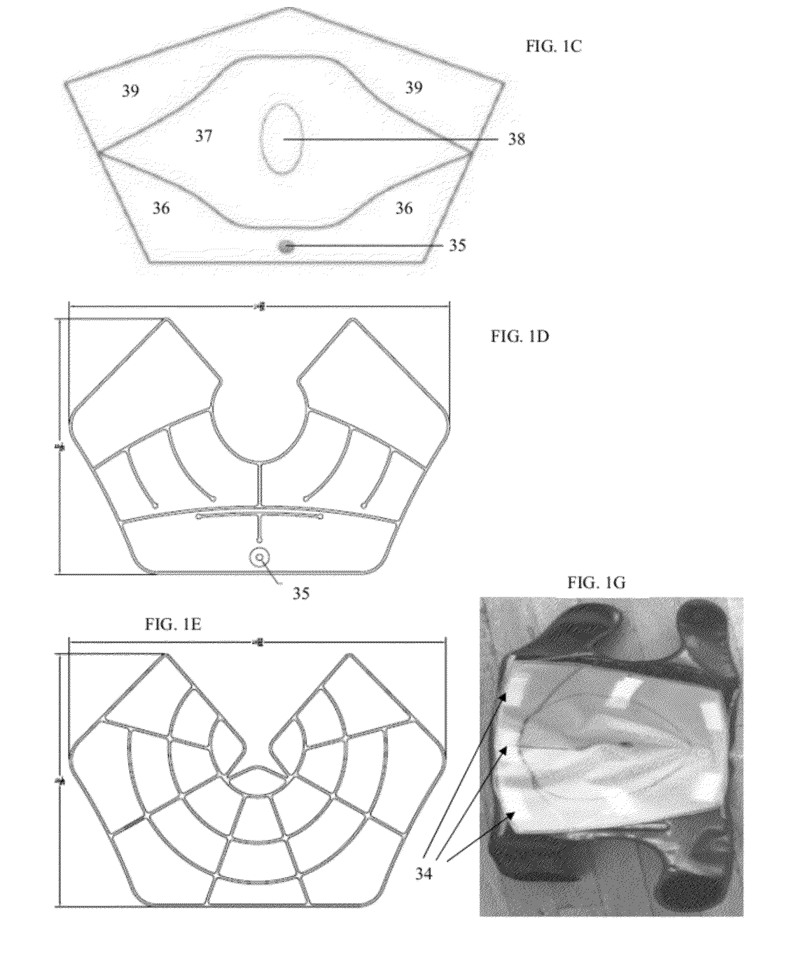

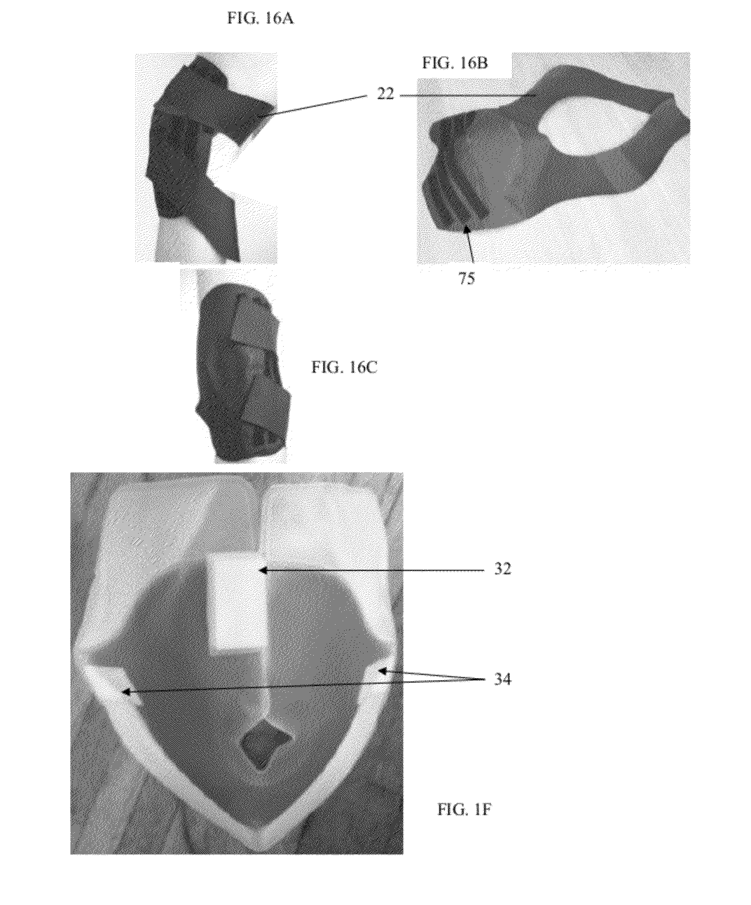

Referring to FIG. 1A, a representative compression device is shown comprising a first segment 20 and a second segment 30. Either or both the first and second segments may be transparent, partially transparent, opaque or combinations thereof. When including the second segment, the first and second segments are cooperative with one another. Cooperation may include a securement or fitting of the first and second segment by one or a number of means for securing 34, including but not limited to adhesive fitting, mechanical fitting, and/or chemical fitting. Suitable examples include fastening with one or more clips, buttons, hooks, magnets, ties, tabs, buckles, snaps, hook and loop, Velcro, adhesive, sewing and any combination thereof. Other means for securing are within the understanding of one of skill in the relevant art. Representative examples of means for securing 34 are depicted in FIGS. 1F, 1G, 4C, 5C, and 6C. The cooperation is, in one or more embodiments, provided at or near the periphery of the segments and does not require, though it may include, securement around the entire periphery; securement may be only at various specific locations between the first and second segments. The cooperation may also include a pocket or housing on the first segment into which all or a portion of the second segment is positioned.

FIG. 1A further illustrates a connecting element 40 adapted for providing a releasable connection between tubing 50 and the device. While connecting element 40 is shown to provide said connection between the tubing and the first segment 20, connecting element 40 may also or alternatively be located to provide a connection between the tubing and the second segment 30. As depicted, connecting element 40 includes a port for providing a fluid connection between tubing 50 and the interior of first segment 20 (and may also include though no shown a port for providing a fluid connection between tubing 50 and/or the interior of second segment 30). Connecting element 70 provides a releasable connection between the tubing and source 60. Connecting element 70 also includes a port for providing a fluid connection between tubing 50 and source 60.

The source may be portable or may be in the form of a machine that is less portable or is fixed. In FIG. 1A, a portable source is shown. In one or more embodiments, a portable source may be about or less than 8 inches in its longest length. The source, whether portable, less portable or fixed provides fluid, via the tubing, ports and connecting means, to the first segment (when connected to the first segment) and/or provides fluid, via the tubing, ports and connecting means, to the second segment (when connected to the second segment). The fluid is generally pressurized (e.g., by way of a pump that fluidly communicates with the device by battery power or other power source). The source may include a controller (e.g., microprocessor) that monitors and/or adjusts pressure and/or temperature. In some embodiments, the source is coupled to a pressure sensor (e.g., for monitoring fluid pressure in the device), a temperature sensor (e.g., for monitoring temperature at a body site), and/or a sensor that measures impedance (e.g., for monitoring impedance at a body site). The source may further include a detachable cover. In addition, the source may also include an analog or digital readout and/or an associated control panel (e.g., with manually or remotely activated switches). The source may further comprise one or more safety features that allow the pump to stop or reduce its pressure when a particular pressure is reached; the safety feature may be coupled to an alarm, a warning light and various combinations thereof. As an example, a source includes a controller operably connected to a compressor and valve mechanism (e.g., solenoid valve), each of which are mounted to a base (e.g., manifold), and a pressure sensor operable with a safety (e.g., valve) mechanism for releasing pressure should pressure become greater than a maximum pressure set for the device. As another example, a source includes a controller operable with a pump, a valve mechanism (e.g., solenoid valve), pressure gauge, muffler and exhaust or release mechanism (e.g., mechanical blow valve or other active or passive mechanism), each of which are operable with the inlet tubing communicating with the pump and bladder. In this embodiment, the pressure gauge is in operable communication with the solenoid valve (regarding opening and pressure release) and with the pump (regarding starting and stopping the pump) and the release mechanism is in operable communication with the bladder as a passive safety mechanism to release pressure should it become greater than a maximum pressure set for the device.

In one or more embodiments, the source is compact and may be removable or permanently positioned on the exterior facing surface of the first segment. Representative examples are depicted in FIGS. 17, 18 and 19. Thus, the source may, in some embodiments, be coupled to and/or be detachable from the device. For portability, the source may include a portable power source (e.g., battery that is solar, electrical or nonelectrical or may be non-battery powered) supplying power to the source components. The source may also include an indicator for battery charge level. When desired, one or more source components may be rechargeable and/or disposable.

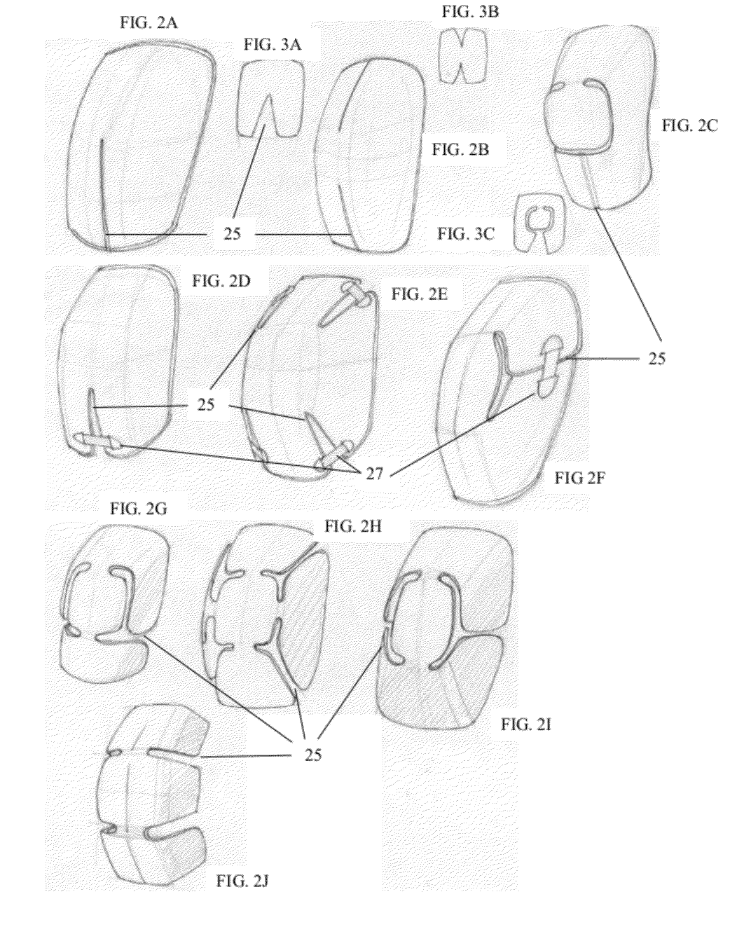

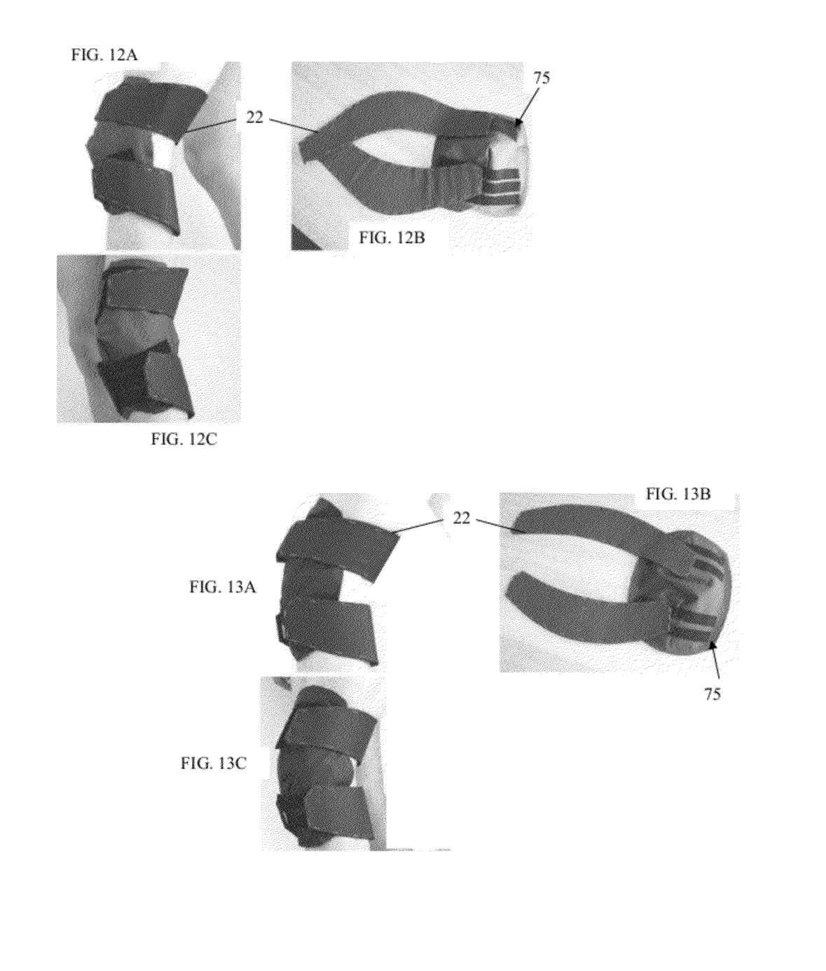

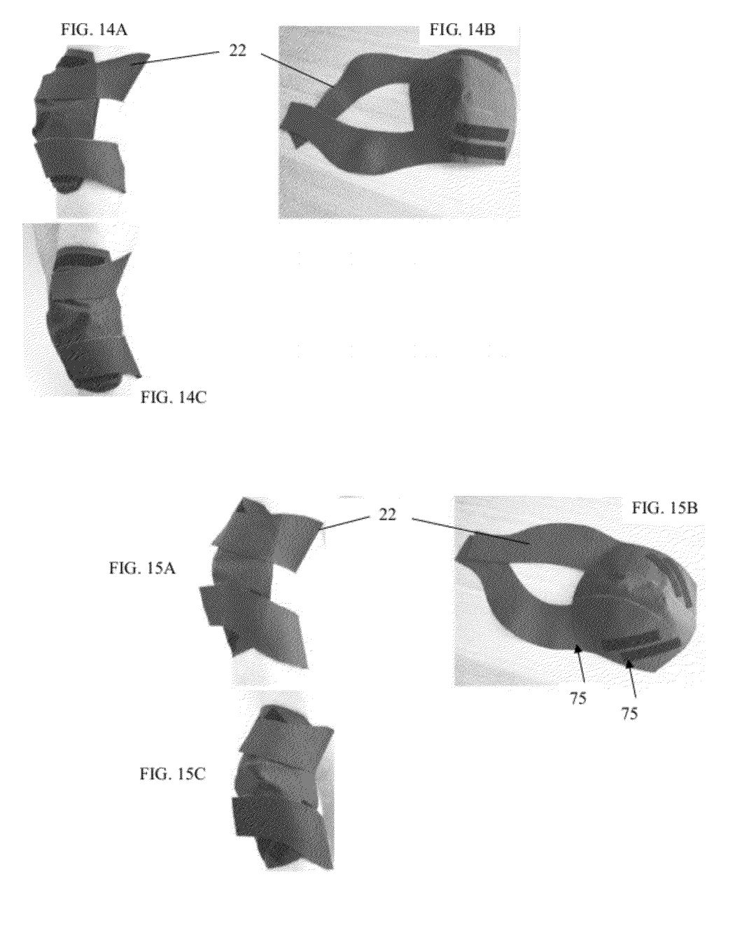

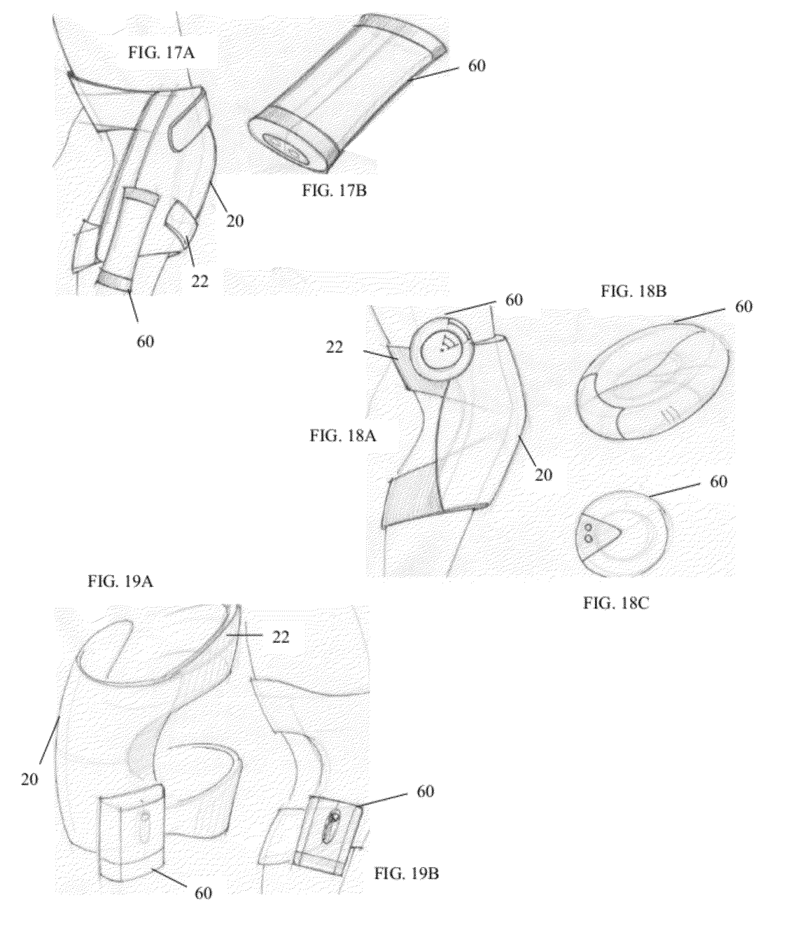

First segment 20 will typically include a body 24, opposing lateral sides 23, a proximal portion 26, which will include a proximal side or edge more proximal to the heart and a distal portion 28, which will include a distal side or edge more distal to the heart. Generally connecting element 40, when positioned on the first segment (or on the second segment) will be placed at or near distal portion 28. Several representative embodiments showing representative configurations for the first segment are illustrated in FIGS. 2-19.

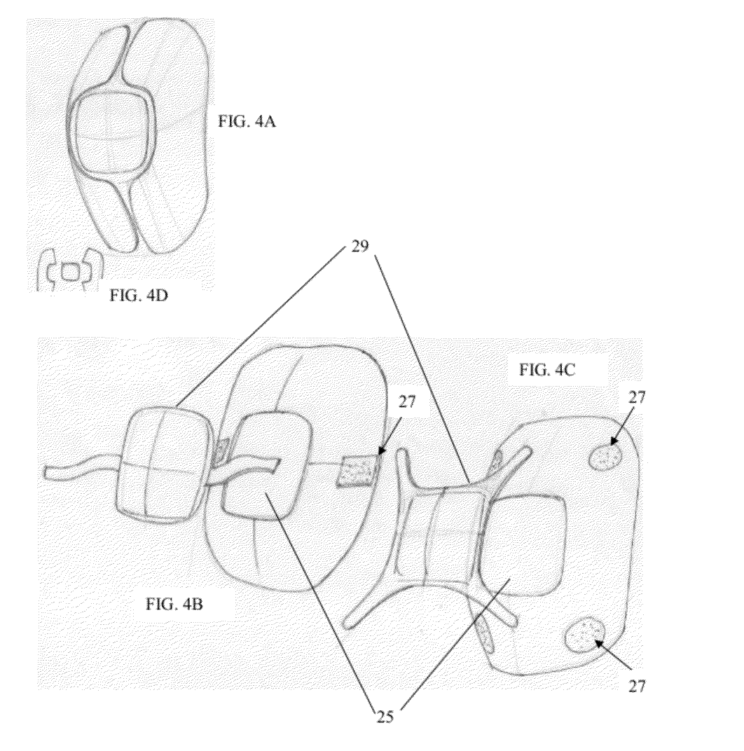

As depicted it the drawings and with additional embodiments, first segment 20 will generally include an improved ergonomic design suited to fit of conform to one or more body sites and anatomic structures. As such, anatomic sites that are irregularly shaped, such as the knee, shoulder, elbow, and ankle, as examples, may include a first segment with a first outward surface that is a receding surface and a second outward surface that is a protruding surface, as exemplified in FIGS. 2A-2J, 4A-4C. To assist in forming said receding and protruding outward surfaces, the first segment may further comprise gaps, slits or spaces 25 and/or closure means or elements 27 on its first outward surface and/or its second outward surface (see FIGS. 2A-2J). The closure means, include are but not limited to adhesive fitting and/or mechanical fitting. Suitable examples include one or more clips, buttons, hooks, magnets, ties, tabs, buckles, snaps, hook and loop, Velcro, adhesive, sewing and any combination thereof. Other means are within the understanding of one of skill in the relevant art. As illustrated in FIGS. 4B 4C, and 6C, the ergonomic design may include detachable portion 29 for improved anatomic fit when desired. The detachable portion(s) may be used to prevent fluid compression or temperature adjustments to one or more specific anatomic sites on or about the body site of interest. As such, the detachable portion(s) will often exclude components for providing fluid compression. The detachable portion may or may not include a temperature adjustable component or temperature sensitive component, as will be discussed further.

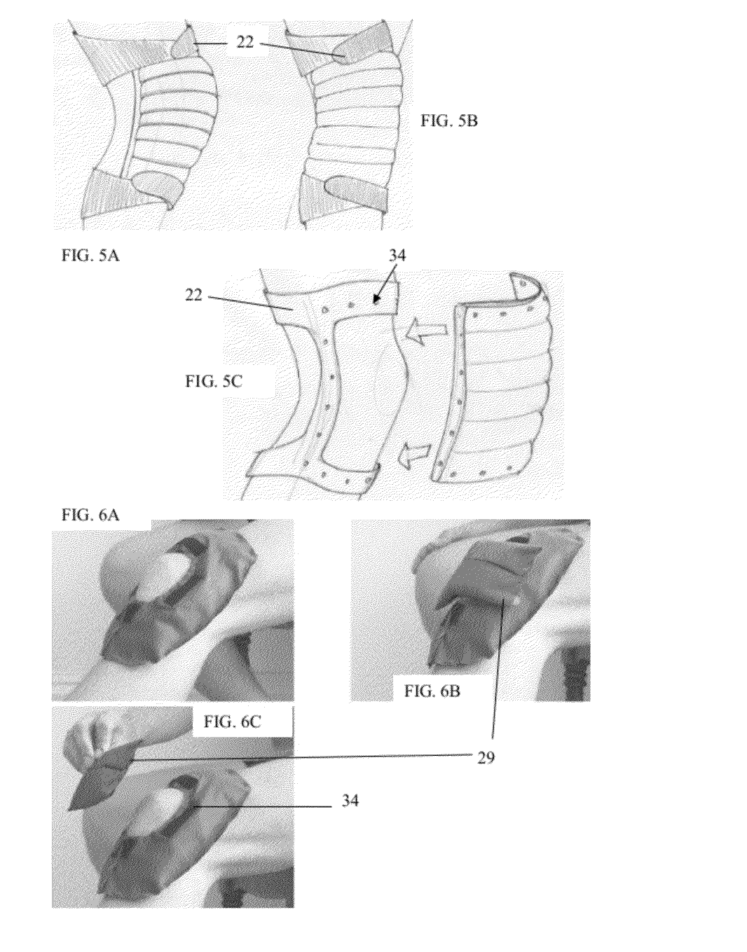

First segment 20 typically further comprises one or more extensions 22. Said extensions may be integral and continuous with first segment 20 (e.g., as depicted in FIGS. 1A, 14B, 15B, 16B) and/or may be separable from the first segment 20 (e.g., FIGS. 5A-5C, 12B, 13B). Additional representative examples of extensions 22 and suitable designs, including those for placement on a front of a knee joint, are depicted in FIGS. 7-11 and 17-19). Further designs not shown would be understood by one skilled in the relevant art. The one or more extension may cooperate with each other and/or the first segment (often on its outside or on its outward surface) by any means for securing or fastening 75, such as but not limited to an adhesive fitting, mechanical fitting, and/or chemical fitting. Suitable examples include securing with one or more clips, buttons, hooks, magnets, ties, tabs, buckles, snaps, hook and loop, Velcro, adhesive, sewing and combinations thereof. Other means for securing are within the understanding of one of skill in the relevant art. Representative examples of means for securing 75 are identified in FIGS. 11A-11B, 12A-12C, 13A-13C, and 16A-16C.

When the body site of interest is located on a limb, the one or more extensions may, in some embodiments, have a length that allows at least one extension to encircle the limb (e.g., FIGS. 8B, 11B, 12B, 13B, 14B, 15B, 16B). Similarly, when the site of interest is located on the trunk of the body, the one or more extensions may, in some embodiments, have a length that allows at least one extension to encircle the trunk, respectively. In addition or in the alternative, a pair of extension may meet one another and cooperate by any means for securing or fastening, such as but not limited to adhesive fitting, mechanical fitting, and/or chemical fitting. Suitable examples include those previously identified, such as one or more clips, buttons, hooks, magnets, ties, tabs, buckles, snaps, hook and loop, Velcro, adhesive, sewing and combinations thereof Other means are within the understanding of one of skill in the relevant art.

The one or more extensions as described herein provide proper placement and assist with ergonomic positioning of the device. The described extension(s) differ from alternative forms because extensions herein are purposefully placed and configured to prevent slippage as well as migration of the extensions due to the surrounding anatomy of an area, including an area or region that said extensions should not be positioned on. For example, in one form the extensions described herein are designed ergonomically to prevent the application of pressure on a portion of the skin or soft tissue that contains sensitive and/or superficial nerves and blood vessels. In addition, the one or more extension, by design and placement ensure correct positioning of the device when under compression. By way of an example of ergonomic design and positioning, the knee is described. The knee includes a region behind the knee joint, the popliteal fossa or popliteal region. This region contains sensitive nerves and blood vessels including the common tibial peroneal nerves, the popliteal vessels, termination of the saphenous vein, an articular branch from the obturator nerve, a lower portion of the posterior femoral cutaneous nerve as well as small lymph glands. To prevent the application of pressure on the popliteal region, the one or more extensions described herein, when cooperative with a device for use on or near the front of the knee joint (used only as an example), are configured in a manner such that each extension extends away from the region behind the knee when at or near the viscinity of the popliteal region while also being positioned ergonomically at or near the edges (proximal and distal edges) of the devices. This specific and unique design prevents the application of constriction on that region. The design further includes a curvilinear shape to the extension, the shape extending away from the popliteal region. The ergonomic design along with the placement at or near the distal and proximal ends of the device prevents migration of the extensions towards the popliteal region, which occurs in alternative designs that are not configured nor placed as described herein. Thus, as described herein is a device designed for protection of one or more sensitive regions near the body site of interest. This is further combined, in many embodiments, with the prevention of any intermittent compression provided to such sensitive regions.

As such, the one or more extensions described herein will, in some embodiments, include curvatures in the extension regions (or a portion thereof) that curve away from a sensitive region at that site. In one example when positioning on a front of a knee joint, with use of a pair of extensions to assist in positioning of the device (each or both extensions meeting one another and/or wrapping around the limb), a first extension(s) is placed on or near the proximal end or portion of the device (thus, when secured, is positioned about the lower thigh region and above the popliteal region) and a second extension(s) is placed on or near the distal end or portion of the device (thus, when secured, is positioned about the upper calf region and below the popliteal region). In another example when the site of interest is the elbow joint and with each or both extensions meeting one another and/or wrapping around the limb, each extension may be placed a distance away from each other (generally extension(s) on a more distal portion or edge of the device as well as on a more proximal portion or edge of the device) with each having a curvature curving away from the sensitive nerves and blood vessels on the inside of the articulating elbow for preventing constriction of the radial and brachial artery and median and radial nerves. Thus, when secured, proximal extension(s) position about a lowermost region or the upper arm and above the inside space of the articulating elbow (to prevent constriction of the inside of the articulating elbow) and distal extension(s) position about the uppermost region of the lower arm and below the inside space of the articulating elbow (to prevent constriction of the inside of the articulating elbow). In a further example when a device is about the wrist, proximal and distal extensions may be placed a distance away from each other (each or both extensions meeting one another and/or wrapping around the limb) and each extension may include a curvature away from the palm side of the wrist and the tunnels therein that support and allow passage of the ulnar nerve and the ulnar artery as well as the median nerve (Guyon's canal and the carpal tunnel) to prevent constriction of said canal and tunnel.

Ergonomic assistance may also be provided by support 80 (e.g., FIGS. 11A, 11B), which may offer a threaded, looped, Velcro-like and/or other suitable configuration for releasable (and moveable) cooperation with extension 22. Support 80 assists in positioning and placement of extensions, as needed.

In one or more embodiments, a described configuration of extensions requires sufficient spacing between extensions and, for many embodiments, includes a curvilinear shaping of at least one of the one or more extensions, in which the curved portion curves away from a particular region to avoid constriction of that particular region as well as preventing migration of the extension towards the particular region. Thickness of the extensions is limited only when preventing constriction of a particular region at or near the body site. In these embodiments, without sufficient spacing and/or curvilinear shaping, the positioning of the extension(s) will be counterproductive. This is because in their absence, migration results in constriction of the particular region, which in some regions may have a detrimental effect.

As described previously, the first segment of the compression device will include two large opposing facing surfaces extending outwardly. The first outward facing surface is the surface that faces the body. This surface may be positioned directly on or about the body site or, in many embodiments includes an intervening surface. An example of the first outward facing surface is depicted in FIG. 1G, in which an intervening surface is shown. The intervening surface may cooperate with the entire first outward facing surface or only one or more portions thereof. In some embodiments, the intervening surface is a protective or resistant surface or layer. The first outward surface of the first segment may also comprise a pocket or housing into which all or a portion of the second segment is positioned. The second segment when included is cooperative with the first outward facing surface (or when included, the intervening surface that resides between the first outward facing surface of the first segment and an outward surface of the second segment). The second outward facing surface of the first segment is the surface viewed when the device is positioned on or about the body site, generally depicted in FIGS. 1A, 2-16, 17A, 18A, and 19A. One or both outward facing surfaces of the first segment may be porous. The outward facing surfaces may also, in some embodiments be of or combined with surfaces that offer water repellency, water resistance, water wicking and combinations thereof

The first and second outward facing surfaces may be on opposing sides of the same composition or material or layer thereof or may be on independent compositions or materials, such that each composition or material is a single layer or multiple layers. When the first and second outward facing surfaces are independent, between the first and second outward facing surfaces is a fluid holding chamber or bladder. When the first and second outward facing surfaces are on the same composition or material or layer, the bladder will be positioned in contact with the first outward facing surface that faces the site of interest (unless there is an intervening layer between the first outward facing surface and the bladder).

The device described herein generally includes only one bladder. The bladder as described herein comprises one or a plurality of chambers, said chambers configured for sequential and directional inflation of the bladder with input of a fluid. The fluid source may be a pump, compressor or other suitable means for introducing fluid into the bladder. The bladder may be at or about the same size as the body portion of the first segment or may be smaller in size than the body of the first segment. The bladder, which expands and contracts with each cycle of compression, as such will, depending on its size, expand and contract all or most or less of the body portion of the first segment. Representative examples of bladders are depicted in FIGS. 1C and 1D. Such a configuration is particularly suitable for placement about a joint, such as a knee joint. Additional configurations and designs are also acceptable as would be understood by one skilled in the relevant art.

The bladder is capable of being filled with fluid, such as air, other gas, liquid or gel and, with each compression cycle, is capable of maintaining said fluid without substantial loss of the fluid. Fluid is introduced into the bladder by way of the fluid source (e.g., source 60 in FIG. 1A) and is directed into the fill port (e.g., port 35 in FIGS. 1C and 1D) generally by way of one or more connecting elements (e.g., connecting element 40 in FIG. 1A). The fluid may be released, dissipate, vent or may exit by ways known in the art. In one or more forms, fluid release occurs by way of a solenoid valve operably coupled with the fluid source (e.g., pump). In other embodiments, a second port may be provided in the bladder and/or as an exhaust (e.g., conduit) associated with the source. Generally, fluid is moved in cycles. The fluid may be introduced for the same cycle duration each time or different cycle durations. With each cycle, fluid may be introduced for the entire inflation period or in pulses or in sinusoidal fluctuations, sometimes only during a portion of the inflation period.

The directional compression provided by the device described herein is such that fluid is filled directionally from a first chamber of the bladder and optionally to at least one or more additional chambers. The first chamber is positioned furthest away from or is most distal from the heart. The remaining chamber(s) when included are closer or less distal than the first chamber with respect to the heart. Thus, in some embodiments, one or more distal chambers fill first followed by one or more less distal chambers. In some embodiments, a single chamber fills passively but is filled at a specific location that is most distal from the heart. In FIGS. 1C and 1D, a fill port 35 is depicted, which will be used to direct fluid into the bladder. In addition, it is noted that for some joints, such as the knee, a bladder may have one or more fluid chambers that are not filled with any fluid, such as depicted in FIG. 1C, with chamber 38, which is a hole or an unfilled space. In one example, fluid is introduced into fill port 35. By way of chamber configuration, fluid will fill chamber 36 first, followed by 37 and finally chamber 39, with no fluid entering chamber 38. As described, in one or more embodiments, fluid enters the bladder in a predetermined and directional fashion, thereby introducing compression to the body site in a sequential and directional manner. For example, the bladder may include channels that direct fluid movement in a directional fashion.

The one or plurality bladder chambers are, in some embodiment, in fluid communication with one another, such that one fluid source is sufficient to introduce fluid to the bladder in a sequential and directional manner. With more than one chamber, the bladder may, in other embodiments, be wholly or partially compartmentalized, which may use the same fluid source (e.g., by way of one or more valves, couplings and/or connecting elements) or, in turn, use additional and/or separate fluid sources to introduce fluid into each of the compartmentalized chambers in a sequential and directional manner. Such chambers may then be individualized with less, negligible or no fluid communication between them. Regardless of the number of chambers and/or fluid sources, the fluid is introduced into the bladder, as described previously, with an initial introduction to one or more first chambers that are most distal from the heart followed by sequentially introducing fluid and, hence compression, to any additional chambers that are located less distal than the first chamber(s) with respect to the heart. As described previously, the bladder may further comprise a discharge unit (e.g., release valve and accompanying components) for release of the fluid, as needed. Access to the discharge unit of the bladder may be through the first segment, when the bladder is fitted within the first segment. Thus, as described herein is a bladder that may contain more than one compartment that inflate sequentially. Sequential inflation may also be introduced by restricting flow between one or more chambers. In some embodiments this may be via a valve, narrowed passage or a regulated valve set to move only in response to a predefined pressure and/or by compartmentalizing the chambers, each chamber associated with a separate fluid source and inflated under a predefined and controlled pattern or sequence or pressure (e.g., via solenoid valves).

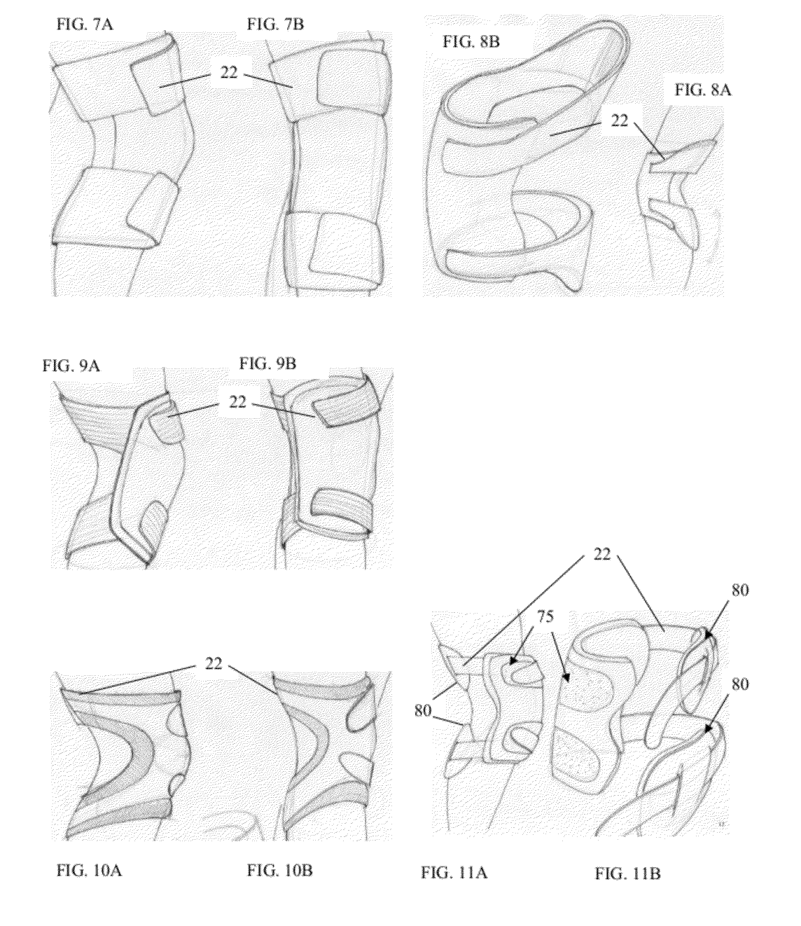

The size of the bladder will depend on the treatment area and location of the body site. In many embodiments, the body site is at or about a joint, including one or more of a finger joint, wrist, elbow, shoulder, hip, knee, ankle, foot and toe joint. The body site may further comprise a portion of the foot, arm (forearm, upper arm), leg (calf, thigh), or lower trunk (lower back, buttocks). When the device is for positioning on or about a joint surface, the bladder is often designed specifically for placement on or about said joint. As depicted in FIGS. 1C and 1D, a bladder is uniquely shaped for configuration about a joint, such as a knee. In many embodiments, the bladder, itself, will not wrap around the entire limb, but will be properly sized to provide compression to only the treatment site. Representative bladder configurations may also prevent compression directly on certain portions of the treatment site, such as depicted in FIGS. 1B, 1C and 6, in which such examples do not introduce compression directly on the patella. Further examples include designs that minimize or avoid pressure on other parts of the body, such as the proximal surface of the proximal phalanx, the lateral malleolus, and the medial malleolus. As an alternative, the entire device, including the bladder may be configured to wrap around a substantial portion of the joint or around the entire limb.

Typically fluid and, hence, compression, is introduced cyclically; the degree of compression depends on the volume of fluid introduced into the bladder. It has been found that by providing specified algorithms for introducing fluid into the bladder, and, hence, compressing the uniquely configured bladder intermittently, treatment of the site may be optimized. With minimal information, treatment algorithms may be prepared for a variety of body sites in order to maximize treatment and provide a more uniform plan of treatment.

In one or more embodiments, the bladder is configured to fit within the first segment and is cooperative with all or a portion of the second segment (e.g., second segment 30 as depicted in FIG. 1A). In some embodiments, the bladder and second segment will have very similar dimensions, such as length and width, while the thickness of the bladder and the second segment may differ. For example, a bladder design such as that represented in FIG. 1C may, in some embodiments, cooperate with a second segment as represented in FIG. 1B, such that chamber 38 of the bladder and region 90 of the second segment are similarly positioned with respect to one another and chamber 37 of the bladder and region 90 of the second segment are similarly positioned with respect to one another. It will be further understood that for certain anatomic structures, the second segment may be further shaped in order to offer an improved mating between the first segment and the second segment when the device is positioned for use. For example, when the first segment is shaped for some anatomic structures to include a first outward surface that is a receding surface and a second outward surface that is a protruding surface, the second segment can be similarly shaped by way of one or more connecting elements (e.g., connecting elements or couplers 32, as represented in FIGS. 1A and 1F). Such connecting elements provided to the second segment allow for a similar surface configuration to the second segment in order that it also includes a protruding surface and an opposing receding surface. Connecting elements or couplers are typically positioned on spaced apart ends of the second segment that are then brought together via the connecting elements. A representative example of such a second segment further shaped with connecting elements to provide a protruding surface and an opposing receding surface is depicted in FIG. 1F.

The second segment is a leakproof element encasing a temperature sensitive component or material. The temperature sensitive component or material described herein is typically a fluid in liquid or gel form but may, in some embodiments, be a malleable or formable solid. In one or more features the temperature sensitive component is a gel and may be a hydrogel. Examples of useful materials for a gel include but are not limited to silica (e.g., vinyl-coated silica gel), hydroxyethyl cellulose, propylene glycol or a slush powder (superabsorbent polymer or superabsorbent crosslinked powder or superabsorbent crosslinked sodium polymer, an example of which is Temtro Dry Gel from Roshgo Corporation, Alpharetta, Ga.). In many embodiments, the temperature sensitive component is capable of achieving a lower freezing temperature than that of water. As such, devices described herein will, when using such lower temperature materials, achieve a temperature in the underlying tissue or body site that is less than what would be achieved with a device that circulates water or ice water. For example, devices that circulate cold or ice water do not achieve a temperature in the tissue that is generally less than about 60 degrees Fahrenheit (F) when applied for short time periods, such as 15 minutes or 20 minutes or 30 minutes (as examples). On the other hand, a device described herein using a temperature sensitive component described herein will achieve a temperature in the underlying tissue that is less than 60 degrees F. and may achieve a temperature in the underlying tissue that is less than 50 degrees F. or even less. The temperature sensitive component may also contain an antifreeze material, such as but not limited to propylene glycol, ethylene glycol, glycerol, and sodium chloride. When included with a temperature sensitive component that contains some water, the antifreeze material will keep the component elastic when it reaches a temperature below the freezing point of water. The temperature sensitive component may further include a chemical indicator that indicates when a desired temperature is met and/or when a desired temperature is lost. The indicator chemical is generally in the form of a dye or a thermochromic ink or may be a chemiabsorbant molecule. In one or more embodiments, the temperature sensitive component is preferably a material that can be adjusted from a first temperature to a second temperature but will return to its first temperature over time (when removed from the second temperature), because the material, when removed from the second temperature can only maintain that second temperature for a set and definite period of time. Such a material is often preferable for treatment of a body site because it is considered safe, according the Federal Drug Administration, since it reduces the risk of direct or indirect injury or damage associated with overheating or overcooling a body site. This is contrasted with a cool or ice water circulating device that has been associated with severe damage as well as frostbite to a body site, such as a limb, when used for a period of time.

Representative examples of leakproof elements are depicted in FIGS. 1A, 1B, 1E, and 1F. As described, the size and shape of the leakproof element may be the same as or similar to that of the bladder described above. As an alternative, the leakproof element may be smaller in general size than the bladder. Such arrangements allow for a unique cooperation between the bladder and the temperature sensitive component, providing a more even distribution of temperature across the one or more areas of compression, which translates to an improvement in the effective temperature achieved in the tissue at the site of interest.

While in some embodiments, the effective temperature achieved in the tissue at the site of interest may be substantially the same across the entire site after providing intermittent compression with a device described herein, in other embodiments, when desired, the effective temperature at portions of the body site of interest may vary. In one or more forms, gradients in temperature may be achieved by compartmentalizing the temperature sensitive component in which some compartments include a larger volume or amount of the temperature sensitive component and/or by offering different pressures to different portions of the bladder. In one example, with reference to FIG. 1B, the second segment will include at least compartments or regions 90, 92, and 94. In one embodiment, region 90 has more temperature sensitive component per unit area than either region 94 or region 92. The amount of temperature sensitive component in region 90 (combined) may be as much as or more than twice the amount in region 94 (combined). The amount of temperature sensitive component in region 92 will, in the embodiment of FIG. 1 B, be nonexistent. However, should the second segment include a non functional compartment or one that includes a small or negligible amount of the temperature sensitive component, the amount of temperature sensitive component in region 92 will, in these embodiments, be small or negligible, respectively. In another embodiment, region 90 has the same amount (per unit area) of temperature sensitive component per unit area as region 94.

Compartmentalization within the leakproof element is desired to reduce movement of the temperature sensitive component. Without compartmentalization, at least some of the temperature sensitive component will migrate when the device is compressed in a sequential and intermittent manner, resulting in the unequal distribution of the temperature sensitive component over time, which will lead to an inability of the device to achieve an even temperature distribution in the underlying tissue. Thus, as described herein, the second segment includes filling compartments to prevent migration of the temperature sensitive component. Said filling compartments may be entirely separate or offer some minimal fluid communication with at least one other compartment. Another advantage of the leakproof elements described herein is that, by allowing them to take one of two shapes (a first initial shape and a second further shape to conform to that of the first segment), they may be readily stacked in its first shape (such as in a freezer) without taking up a significant amount of space. Thus, when desired, the leakproof element may be quickly replaced by another, such as when the temperature sensitive component is no longer capable of achieving a desired temperature.

In some embodiments, a combination of sequential and intermittent compression associated with the first segment and a unique distribution and compartmentalization of the temperature sensitive component in the second segment is provided. Still further, said compartmentalization of the temperature sensitive component in the second segment may be further combined with and be specifically coordinated with the bladder, such that the bladder (associated with the first segment) and the second segment are similar or substantially the same in their overall shape (e.g., similar in at least two dimensions). Moreover, the bladder may also be compartmentalized, having at least more than one chamber that cooperates with similarly positioned compartments in the second segment in order to maintain a uniform distribution of the temperature sensitive component housed in the second segment. The bladder may be compartmentalized, having one or more chambers that cooperate with similarly positioned compartments in the second segment, in which one or more compartments in the second segment include a similar or substantially the same volume (amount) of temperature sensitive component in the one or more compartments. In the alternative, the bladder may be compartmentalized, having one or more chambers that cooperate with similarly positioned compartments in the second segment, in which one or more compartments in the second segment include differing volumes (amounts) of temperature sensitive component. Thus, as described, is a leakproof element housing a temperature sensitive component that when positioned as described and aligned with the first segment provides a compression system offering improved temperature distribution as well as a colder temperature to the underlying body site. The device described will, by pressure or amount or type of temperature sensitive component, be uniquely designed to provide a specified temperature or temperature range to the underlying body site. The device described herein is capable of specifying the type of temperature sensitive component, the amount (volume) of the temperature sensitive component and/or the pressure algorithm applied. In addition, when desired, the distribution of temperature across the underlying body site (from one location to another) may be more specifically regulated by compartmentalizing the temperature sensitive component is and/or specifying the distribution of the temperature sensitive component within compartments of the second segment.

A predetermined algorithm described herein may be provided to achieve a desired treatment outcome. It has previously been understood that when a cold ice pack is applied continuously with some pressure to an anatomic site, the longer the time of application of the cold pack the colder the surface of the skin (just below the cold pack) will be (e.g, Janwantanakul P, Physiotherapy 2006; 92(4):254-259). As described herein, compression, applied intermittently, was found to significantly increase the cooling effect on the tissue surface as well as within the tissue (below the tissue surface) (see also Tables 2-4). The described invention has thus, with the application of intermittent compression, been able to alter the amount of compression of the device (pressure) in relation to the total treatment time in order to achieve skin temperature values that are the same or similar (for each treatment scenario). Thus, when a certain relative tissue temperature is desired and the total time for treatment is to remain the same, the pressure level and compression time will be varied as it relates to the time of inflation. In this manner, the total time of inflation and the amount of pressure only are manipulated (while total time of treatment remains the same). In some embodiments, there will then be a general decrease in the total time of inflation when the amount of pressure is increased. In other embodiments, the compression level will be changed (with the same device) in order to achieve a same (or similar) temperature with or without changing the compression time.

Thus, by performing only a few test runs with a device described herein (the device having a specific temperature sensitive component), one will be able to set the device to provide, a similar temperature profile to the anatomic site when intermittent compression is applied by said device. Accordingly, as described herein, is a standardized treatment of care to a site of interest in order to achieve good efficacy and outcome over several separate treatment sessions.

In a first example, a compression device described herein had a first segment with a bladder provided within its body portion; the bladder had a fill hole at its more distal end that introduced pressure via a portable pump that inflated the bladder from the distal end to the proximal end. The bladder in a centermost region had a hole, which, therefore, did not inflate. The first segment had a first outward facing surface that was recessed near its more center region and a second outward facing surface that protruded near its more center region. The first segment as described is suitable for an anatomic structure such as a joint which has an anatomic portion that protrudes or is for use when a joint is bent. The first segment, with or without the protruding and recessed facing surfaces, may also be used on other anatomic structures. The first segment included a pair of extensions at its more distal end and a pair of extensions at its more proximal end. The pairs of extensions were each curved, with curvatures that prevented the extensions from migrating towards one another (arcs curving outwardly, away from the center of the device). The pairs of extensions each had mating connections and hence were capable of securely wrapping about a limb. The second segment had an overall general shape that was similar to the general shape of the bladder in the first segment, with the exception of spaced apart edges on the second segment with a small gap therebetween. The second segment was compartmentalized with at least two regions, each region contained a different volume (per unit area) of a temperature sensitive material, such that the peripheral portion of the second segment contained significantly less of the temperature sensitive component than did the inner more portion. The inner more region of the second segment had a shape that was generally similar to that of the bladder. This region also contained the temperature sensitive component, which was a cooling hydrogel that had a freezing temperature below that of water. The second segment was stored in the freezer until use and when removed from the freezer was formable. The second segment included several connections positioned on one of its outward facing surfaces at various points near the periphery; the connections affixed to mating connections on one of the outward facing surfaces of the second segment. The second segment before being affixed to the first segment was shaped by couplers or fasteners positioned near the spaced apart ends and was, by means of the couplers, shaped similar to that of the first segment (thus having one outward facing surface that was recessed near its more center region and an opposing outward facing surface that protruded near its more center region). The second segment had a hole in a centermost region and, when shaped and then affixed to the first segment, the hole in the second segment generally aligned with the hole in the bladder. When the device was secured about the joint, pressure was introduced cyclically into the bladder by a portable pump. The bladder inflated only intermittently and each inflation period compressed only the inner more region of the second segment that was shaped generally similar to that of the bladder. The combination, as described, provided, over time, uniform pressure along the entirety of (or most of) the temperature sensitive component, which translated to a more uniform change in temperature to the underlying tissue (the change directed by the temperature sensitive component). In addition, the combination, as described (sequentially compressing only the temperature sensitive component in an intermittent manner), was found to provide a faster temperature change in the underlying tissue.

It will be understood that while a more uniform compression of the temperature sensitive component may be suitable for some anatomic structures, other anatomic structures may be better suited to have an unequal compression of the temperature sensitive component, which can be readily performed by adjusting the volume (per unit area) of the temperature sensitive component in the second segment while providing a generally uniform pressure across all areas housing the temperature sensitive component.

The described device (offering a generally uniform volume [per unit area] of the temperature sensitive component in the second segment while providing a generally uniform pressure over time across all areas housing the temperature sensitive component) was used to apply intermittent compression to a joint, such as the front of a knee. Representative intermittent compression conditions that achieved a relatively uniform cooling and a fast cooling to the underlying tissue (when the temperature sensitive component was a cooling component and the housing for the temperature sensitive components had a shape that was overlapped by the bladder) are presented in Table 1.

TABLE 1

| Pressure | Inflation | Deflation |
|---|---|---|
| (mmHg) | (sec) | (sec) |
| 50 | 40 | 30 |
| 70 | 35 | 35 |
| 90 | 30 | 40 |

In the conditions provided above, the total time of compression (inflation and deflation) was about 15 minutes. The total time of compression may also be about 16 minutes. Additionally, the total time of compression may be about 10 minutes or about 20 minutes or about 25 minutes or about 30 minutes, or about 60 minutes, or about 90 minutes, or about 120 minutes or several hours. Total time of compression may be shorter or longer depending on the tissue and/or anatomic location. In some embodiments, the temperature sensitive component will determine the total time of compression because of the inherent characteristics of the temperature sensitive component.

While representative pressures are depicted in Table 1, it will be understood that other pressure may be used. In one or more embodiments, the period of inflation is the same as the period of deflation. In additional embodiments, the period of inflation is not the same as the period of deflation. The period of inflation may be from about 15 seconds to about 20 seconds, or about 25 seconds, or about 30 seconds, or about 35 seconds, or about 40 seconds, or about 45 seconds, or about 50 seconds, or about 55 seconds, or about 60 seconds, or about 90 seconds, or about 120 seconds. Similarly, the deflation period may be from about 15 seconds to about 20 seconds, or about 25 seconds, or about 30 seconds, or about 35 seconds, or about 40 seconds, or about 45 seconds, or about 50 seconds, or about 55 seconds, or about 60 seconds, or about 90 seconds, or about 120 seconds. It is also within the scope of the invention to maintain a minimum or base amount of pressure in one or more of the chambers throughout an inflation and/or deflation period.

In one of many representative arrangements, an apparatus described herein included a pump that inflated air into a bladder positioned within the first segment of the device. The pump delivered intermittent pressure to the bladder in cycles that were pre-set. The pump included three pre-defined settings that delivered air to the bladder for a total time for compression of sixteen minutes, each setting offering a different pressure with a different cycle pattern. The pre-defined settings were similar to those presented in Table 1. The pump was housed in a unit small enough to allow it to be handheld, placed in a dedicated wearable pouch or strap, carried in the user's pocket, carried on the user's belt or removably coupled to the exterior of the first segment itself. The pump unit was powered by a battery or by an alternating current. The pump was controlled by a controller, coupled to a valve, pressure gauge, muffler and exhaust mechanism; with a safety pre-set to stop compression if the bladder inflated beyond a predetermined pressure, which, in this embodiment, was 10 mmHg beyond each pre-defined pressure setting. When the pump inflated a device described herein, the device was compressed sequentially and intermittently from its distal portion to its proximal portion. The sequential flow pushed fluid in the underlying tissue towards the center of the body (trunk) rather than to the periphery of the body.

Additional features that may be combined with a device and components described herein include one or more temperature and/or pressure sensors to provide feedback or alarms for the described device (e.g., pressure and/or temperature on the skin or within parts of the device, itself), a keyboard or push button or other interface to input parameters and data, and microchips or indicators (e.g., LED indicator) that provide a digital or analog readout or display of the pressure or temperature during and after usage of the described device. Optionally a remote unit or external device (wired or wireless, including use of smartphone or other external device) may be provided with the device for remote operation, and to download data and/or applications for use with the device. For example, one or more data programs may be accessed by an external device for specific operation of the device at a specific anatomic body site. As an alternative to an internal source of pressure, the device described herein may be operational with an external source of pressure.

Examples of the described device in operation are provided below. Some examples include alternative (comparative) devices that were unable to achieve the same results as the described device.

In a first example, a compression device described herein, similar to one depicted in FIGS. 1A and 1C, was wrapped round a 4 lb piece of beef muscle contained in saran wrap. A 2-inch thermometer probe was used to measure temperature of the muscle at its surface, as well as 1 cm, 2 cm, 3 cm and 4 cm below the surface. The compression device was inflated with air and the temperature sensitive component was a hydrogel that had been cooled to 0 degrees F. prior to use. The cooled hydrogel (in its housing) was in contact with the saran wrap. An electric pump introduced intermittent sequential compression to the compression device at a pressure of 50 mmHg; each cycle included 40 seconds of inflation following by 30 seconds of deflation. The beef muscle was compressed for a total compression time of 15 minutes. The temperature of the beef muscle was measured before application of the device and 15 minutes after application of the device. A control sample (same sized beef muscle) had the same device (with a hydrogel that has been cooled to 0 degrees F.) wrapped about the muscle but without activation of the pump and hence no intermittent compression.

Data showing results with intermittent cold compression as compared with only cold compression are shown in Table 2. Each data was an average after performing three separate measurements.

TABLE 2

| | Temperature (F.) | | Temperature (F.) | |
|---|---|---|---|---|
| Depth (cm) | IC (0 min) | No IC (0 min) | IC (15 min) | No IC (15 min) |
| 0 | 66.7 | 67.8 | 41.6 | 53.5 |
| 1 | 66.5 | 67.7 | 46.1 | 56.6 |
| 2 | 66.5 | 67.6 | 49.8 | 58.9 |
| 3 | 66.4 | 67.4 | 52.9 | 60.4 |
| 4 | 66.2 | 67.4 | 55 | 61.3 |

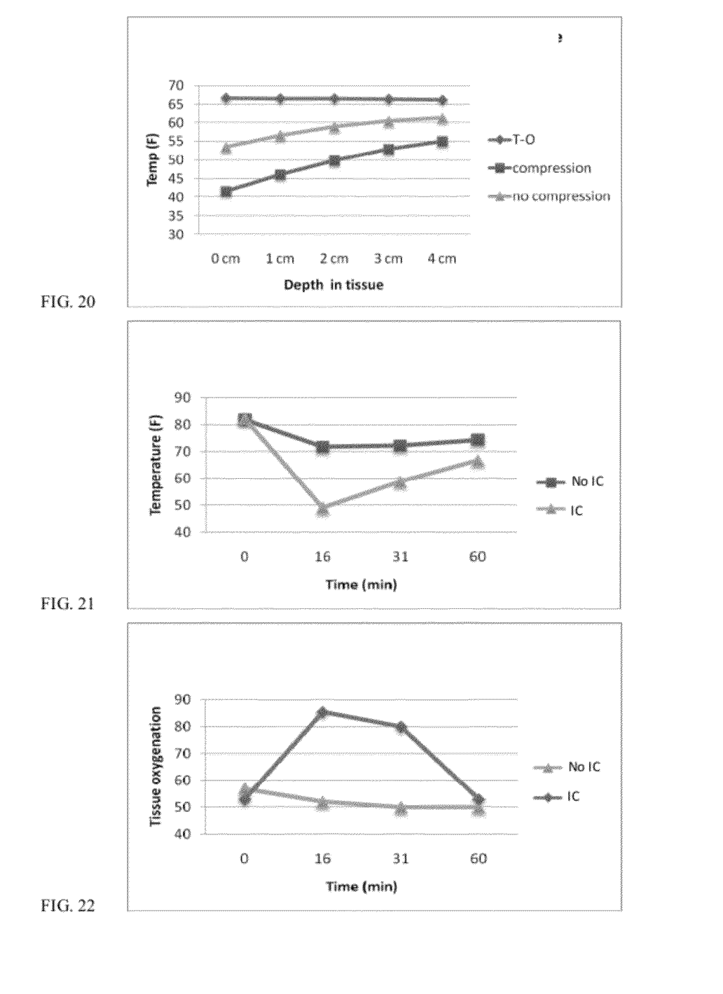

Temperatures well below 50 degrees F. were achieved in muscle tissue that was provided 15 minutes of intermittent cold compression as compared with muscle that was provided only 15 minutes of cold without intermittent compression. With cold alone, the temperature in either the surface tissue or the deeper tissue was never below 53 degrees. This is further exemplified in FIG. 20, in which T-0 is the average of IC (0 min) and No IC (0 min), compression is that which was achieved after 15 minutes of intermittent compression using the cold compression device described herein and no compression is that which was achieved after 15 minutes of the cold device without intermittent compression.

In another example, the described device, similar to one depicted in FIGS. 1A and 1C, was compared with a comparative cold compression device that does not apply intermittent compression. The comparative device (Moji Knee, by Moji, Inc., Glenview, Ill.) is a two-piece design with an outer wrap that surrounds the front of the knee joint having upper and lower stretchable (migratable) straps that each wrap around the leg (above and below the knee, each strap connecting back to the front of the wrap). A second piece is an interior cold cell unit with about 20 independent cold cells that are physically separated from each other and surround the front and sides of the knee joint.

The described device had a hydrogel that had been cooled to 0 degrees F. prior to use. The cold cell unit of the comparative device was also initially cooled to 0 degrees Fahrenheit before use. Both the described device and the comparative device were positioned on one knee of the same person. Treatment time was 16 minutes for both devices; however, the described device was also compressed intermittently via an air pump for 10 cycles of compression at 50 mmHg that included 45 seconds of inflation and 30 seconds of deflation. Both devices were removed after the 16 minute treatment time. Skin temperature was measured on the inner side of the knee just below the patella and oxygenation was measured on the inner and outer sides just below the patella; all measurements were taken at 0 minutes, 16 minutes, 31 minutes and 60 minutes after treatment intitiation. To obtain oxygenation measurements, a near infrared spectroscopy unit (InSpectra™ Monitor, model 650, a trademark of Hutchinson Technology Incorporated, Minnesota) was used.

Immediately after application of compression, both devices were removed and the knees were visualized as well as photographed. The left knee, to which the described invention was positioned, showed more visible redness, pointing to increased blood flow. Further data is shown in Table 3. Each data was an average after performing three separate measurements.

TABLE 3

| | Skin Temperature | | Oxygenation | | Oxygenation | |
|---|---|---|---|---|---|---|
| Time | (F.) | | (inner knee) | | (outer knee) | |
| (min) | IC | No IC | IC | No IC | IC | No IC |
| 0 | 82.4 | 81.9 | 53 | 57 | 62 | 62 |
| 16 | 49.1 | 71.8 | 85.5 | 52 | 87 | 58 |
| 31 | 58.9 | 72.2 | 80 | 50 | 85 | 55 |
| 60 | 66.9 | 74.4 | 53 | 50 | 71 | 62 |

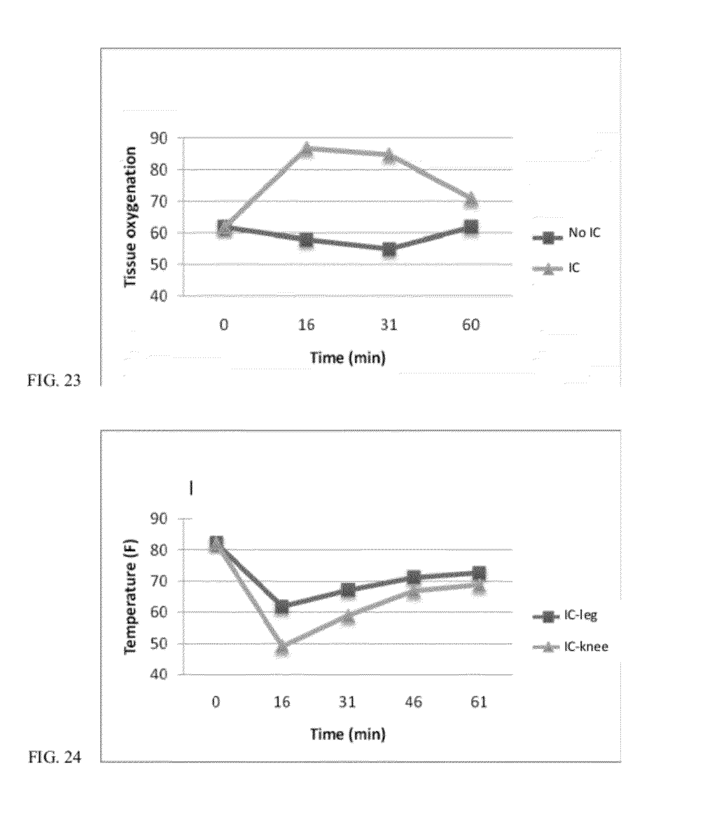

Results differed when a knee was provided intermittent cold compression with a device described herein as compared with only cold compression using a comparative device. For example, tissue near the knee reached a temperature of 49.1 degrees F. when treated with the described device (IC) and only reached a temperature of 71.8 degrees F. when treated with the comparative device (No IC). In addition, tissue oxygenation near the inner side of the knee increased by 61% when treated with the described device (IC) as compared with no apparent effect with the comparative device (No IC). The same was found with the outer side of the knee, which showed an increase in oxygenation of 40% after treatment with the described device (IC) as compared with no apparent effect after treatment with the comparative device (No IC). This is also exemplified in FIGS. 21-23, which show that the lowest skin temperatures and highest oxygenation amounts were achieved with application of the device described herein, which included a temperature cooling material combined with application of intermittent compression directed site specifically.

In a further example, a device described herein, similar to one depicted in FIGS. 1A and 1C, was compared with a comparative device that applies intermittent compression in a different manner and non-site specifically. The described device had a hydrogel that had been cooled to 0 degrees F. prior to use. The comparative device (Game Ready® Knee Wrap; a trademark of CoolSystems, Inc., Concord, Calif.) is a water cooled compression wrap that encircles a large portion of the leg from above the ankle to mid thigh. The comparative device circulates over the entire wrap cold or ice water in an inner chamber and has an outer air chamber that inflates and deflates air over the entire wrap at a fixed pressure setting. The described device was positioned on one knee of a person and the comparative device was positioned on the other leg of the same person. Both devices were activated for sixteen minutes and then removed thereafter. The described device was pre-programmed for 10 cycles, each including compression for 45 seconds and deflation for 30 seconds at a pressure of 50 mmHg. The comparative device was wrapped around the entire leg and set to its maximum cold setting and a medium compression setting. Skin temperature was measured on the inner side of the knee just below the patella and oxygenation was measured on the inner and outer sides just below the patella; all measurements were taken at 0 minutes, 16 minutes, 31 minutes, 46 minutes and 60 minutes following treatment initiation. To obtain oxygenation measurements, a near infrared spectroscopy unit (InSpectra™ Monitor, model 650, a trademark of Hutchinson Technology Incorporated, Minnesota) was used.

Immediately after application of compression, both devices were removed and the knees were visualized as well as photographed. The left knee, to which the described invention was positioned, showed more visible redness, pointing to increased blood flow. Additional data are presented in Table 4. Each data was an average after performing three separate measurements. The described device achieved a lower tissue temperature about the knee. In addition, the described device improved oxygenation about the knee.

TABLE 4

| | Skin Temperature | | Oxygenation | | Oxygenation | |
|---|---|---|---|---|---|---|
| Time | (F.) | | (inner knee) | | (outer knee) | |
| (min) | IC-knee | IC-leg | IC-knee | IC-leg | IC-knee | IC-leg |
| 0 | 82.4 | 82.25 | 67 | 61 | 68 | 65.5 |
| 16 | 49.1 | 61.8 | 92.5 | 58 | 89.5 | 73.5 |
| 31 | 58.9 | 67.1 | 92 | 55 | 82 | 64 |
| 46 | 66.9 | 71.2 | 71 | 48 | 71 | 58 |
| 60 | 68.8 | 72.7 | 56 | 45 | 55 | 54 |

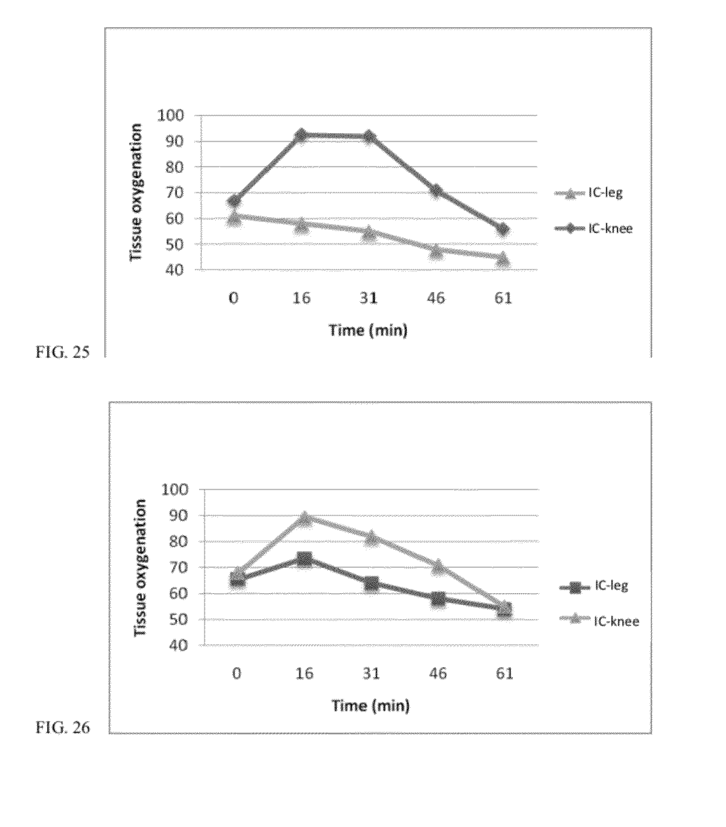

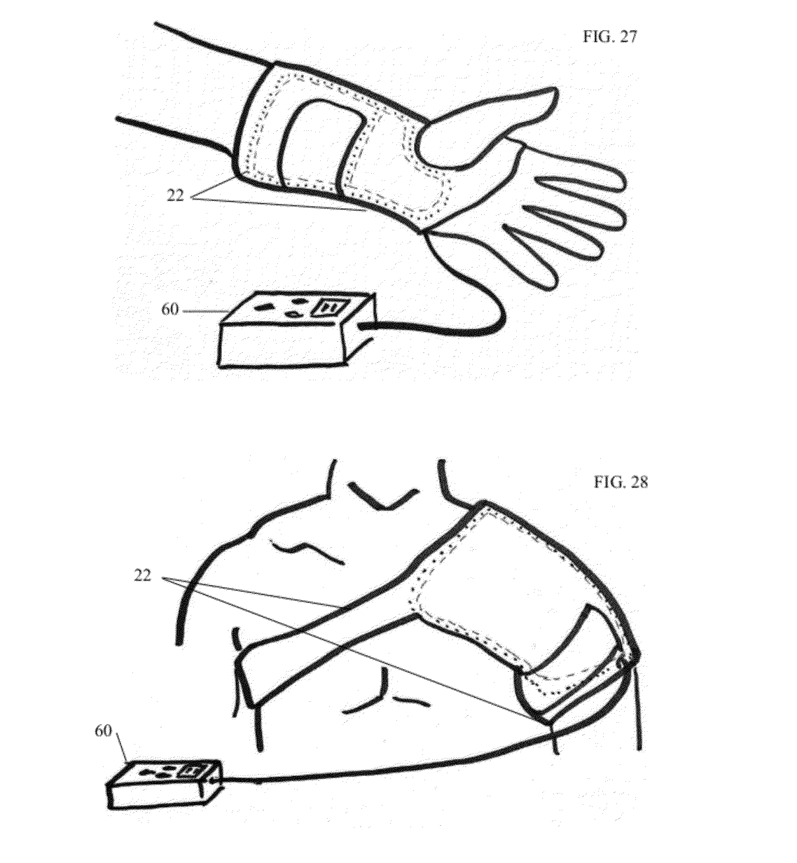

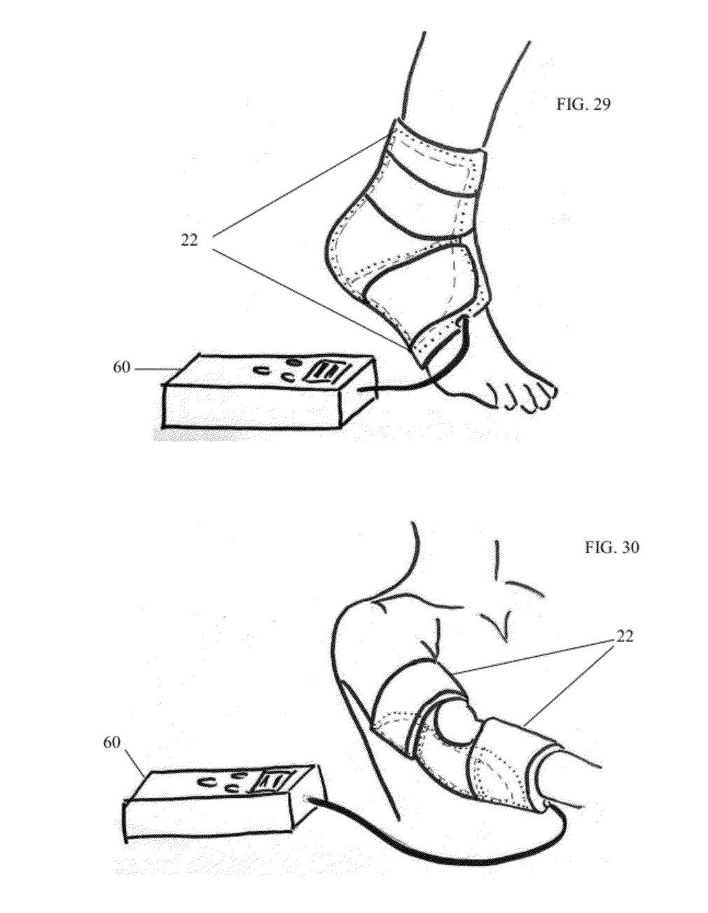

This is further exemplified in FIGS. 24-26, which, together, show that lower tissue temperatures and higher oxygenation amounts were achieved with application of the device described herein by providing site specifically with intermittent compression a temperature cooling material at a desired temperature, likely cooler than the comparative device. Tissue oxygenation measured at the inner side of the knee increased by 38% with the described device (IC-knee) as compared to no apparent effect recorded after use of the comparative device (IC-leg). Tissue oxygenation measured at the outer side of the knee increased by 32% with the described device (IC-knee) as compared to no apparent effect recorded after use with the comparative device (IC-leg).

FIGS. 27-30 show representative devices for positioning around other anatomic structures of the body, including the wrist (FIG. 27), shoulder (FIG. 28), ankle (FIG. 29) and elbow (FIG. 30). In these illustrations, the temperatures sensitive element is shown to be housed in a second segment that is slightly smaller in overall size (see dashed lines) than the bladder (see dotted lines). FIGS. 27 and 29 show that each of the housings for the temperature sensitive component and the bladder are defined by two compartments or chambers. FIG. 28 shows that the housing for the temperature sensitive component and the bladder are defined by one compartment or chamber. FIG. 30 shows that each of the housing for the temperature sensitive component and the bladder are defined by three compartments or chambers. Each of said representative embodiments shows one of many representative designs, such as extension elements 22 and source 60. It is understood that alternative designs may be readily contemplated for the fluid source, first segment, extension elements, bladder, and temperature sensitive component housed in a second segment, each of which may be of many alternative sizes and configurations.

Thus, as described, are devices that deliver sequential and intermittent compression to one or more anatomic sites on a person. The device takes advantage of achieving a more uniform temperature and faster temperature adjustment to the anatomic site of interest as well as providing consistent temperature changes by including one or more of the following: using a temperature sensitive component that is malleable and has a freezing temperature that is below that of water, preferably with a long hysteresis; an inflatable bladder uniquely designed to provide compression site specifically and generally uniformly to the temperature sensitive component; a temperature sensitive component in a housing that is compartmentalized to prevent migration of the temperature sensitive component; an inflatable bladder that is generally in a similar size and shape or slightly larger than the housing for the temperature sensitive component; a housing for a temperature sensitive component that includes chambers in a configuration that is similar to compartments in the bladder; ergonomic extensions or straps with curvature that prevent movement or migration of the extensions, particularly to a sensitive portion of the body; the use of a time adjusted compression system that allows a user to achieve the same temperature efficacy with different pressures.

Although representative devices, components and methods of use have been described in detail herein, those skilled in the art will recognize that various substitutions and modifications that may be made without departing from what is described and shown as well as defined by the appended claims.

What is claimed is:

1. An apparatus configured for placement on a person at a body site, the apparatus comprising:
a first segment cooperative with a fluid chamber, the fluid chamber adapted for inflation by fluid from a fluid source; and
a second segment cooperative with the first segment, the second segment housing a temperature sensitive material, wherein the temperature sensitive material is compartmentalized in the second segment in a manner that prevents migration.

2. The apparatus of claim 1, wherein the temperature sensitive material includes a chemical indicator.

3. The apparatus of claim 1, wherein the temperature sensitive material is a hydrogel.

4. The apparatus of claim 1, wherein the first segment is shaped for positioning about only a portion of a joint.

5. The apparatus of claim 1, wherein the second segment is further shaped prior to its cooperation with the first segment.

6. The apparatus of claim 1 further comprising one or more fasteners cooperative with and extending from the first segment for securing the first and second segments about the body site.

7. The apparatus of claim 1, wherein the fluid introduced to the fluid chamber is controlled by predefined settings.

8. The apparatus of claim 1 further comprising one or more ergonomically positioned fasteners cooperative with and extending from the first segment for securing the first and second segments about the body site without compressing one or more sensitive regions near the body site.

9. The apparatus of claim 1, wherein inflation of the fluid chamber is performed by a portable unit adapted for and coupled with the first segment.

10. The apparatus of claim 1, wherein the fluid chamber is contained within the first segment.

11. The apparatus of claim 1, wherein housing for temperature sensitive material and the fluid chamber are of a similar size in at least two dimensions. 136971-1000

12. The apparatus of claim 1, wherein housing for temperature sensitive material and the fluid chamber each include the same number of compartments that overlap when the second segment is cooperative with the first segment.

13. The apparatus of claim 1, wherein a control unit controls operation of the apparatus, the control unit selected from the group consisting of external device, internal controller and combinations thereof

14. A therapy system for use with a body site of a person, the system comprising:
a first segment comprising a fluid chamber adapted for inflation;
a second segment comprising a temperature sensitive material, wherein the temperature sensitive material is compartmentalized in the second segment to prevent migration, and wherein, the first and second segments are removably coupled to one another;
a fluid source fluidly coupled to the fluid chamber; and
one or more extending members for coupling to and extending from the first segment, the one or more extending member for securing the first segment about the body site, wherein at last a portion of the one or more extending members are shaped curvilinearly to prevent their migration from an initial position.

15. The system of claim 14, wherein inflation is intermittent.

16. The system of claim 14, wherein inflation of the fluid chamber provides compression to all of the temperature sensitive material in a sequential manner.

17. The system of claim 14, wherein the fluid chamber is contained within the first segment.

18. The system of claim 14, wherein the fluid chamber overlaps substantially all of the temperature sensitive material to provide compression to substantially all of the temperature sensitive material.

19. The system of claim 14, wherein the system further comprises a control unit having one or more predefined algorithms for achieving a desired temperature on the body site by adjusting one or both of a fluid pressure and time of inflation associated with the fluid chamber.

20. A method of introducing a therapy system on a person at a body site comprising:
providing an apparatus to only the body site, the apparatus comprising:
at least a first segment cooperative with a fluid chamber, the fluid chamber adapted for intermittent inflation by a fluid;
a fluid source fluidly coupled to the fluid chamber to introduce the fluid to the fluid chamber; and
one or more extending members ergonomically positioned for coupling to and extending from the first segment and for securing the first segment about the body site without migrating from an initial position; and
introducing fluid intermittently for a defined period of time to the fluid chamber thereby intermittently compressing only the body site while maintaining the one or more extending members in their initial position.

21. The method of claim 20, wherein the method includes coupling a temperature sensitive material with the first segment.

22. The method of claim 20, wherein the fluid chamber is compartmentalized introducing fluid sequentially and intermittently to the body site, wherein the sequential compression is from a distal portion of the body site to a proximal portion of the body site.
